(19) United States
(12) Patent Application Publication
(10) Pub. No.: US 2004/0057724 A1
(43) Pub. Date: Mar. 25, 2004

(54) Maintaining quality of packet traffic in optical network when a failure of an optical link occurs

(76) Inventors: Markku Oksanen, Helsinki (FI); Antti Pietilainen, Espoo (FI); Ronald Brown, Helsinki (FI); Aki Grohn, Espoo (FI); Reijo Juvonen, Helsinki (FI); Harald Kaaja, Helsinki (FI); Ari Tervonen, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/250,573

(22) PCT Filed: Jan. 4, 2001
(86) PCT No.: PCT/FI01/00012

(51) Int. Cl. G02F 1/00

(52) U.S. Cl. 398/5

(57) ABSTRACT

Interworking of optical protection in an optical network and IP-layer protection in the Internet is achieved by configuring optical links to form a part of a ring network and by arranging different protection types for different links. Each optical link is provided with an appropriate protection level corresponding to the nature of Internet traffic being transmitted over the link. The highest protection level is achieved with 1+1 protection. The optical layer can offer this protection for high priority Internet traffic that does not tolerate delay. The middle and the low protection level are achieved with 1:1 protection. The low protection level of a link does not guarantee uninterrupted transmission of the Internet traffic, in case of link failure caused by a fiber cut. Optical signaling at the optical layer takes care of protection wherein the IP-layer does not know when protection actions are carried out. At the IP layer different quality-of-service parameters are assigned to the optical links of different priority. Then routers create different routing tables for different quality-of-service classes.

### FIELD OF THE INVENTION

The invention relates generally to supporting packet traffic in an optical network, especially protecting Internet traffic when a failure of an optical network link occurs.

### BACKGROUND OF THE INVENTION

FIG. 1 shows the OSI and TCP/IP communications models. The seven-layer OSI model came from work done by standards committees whereas the four TCP/IP layers, built on top of a hardware layer, came out or practical work done by researches. The session and presentation layer functions defined in by the OSI model are omitted from the TCP/IP model, and the functions are fulfilled as needed by different TCP/IP protocols.

In the TCP/(IP model a user interacts with a network application at the application layer. Data is received as command from the user and as data from the network application on the other end of the connection. TCP/IP applications communicate in client/serve pairs. The transport layer manages the flow of data between two inter-network hosts using TCP (Transmission Control Protocol). At the network layer data is moved around the Internet. Internet Protocol (IP) operates at this layer to route packets across networks independent of the network medium. The data link layer, also known as the network interface layer, serves for transmitting data across a single network. Physical networks consist of several kinds of physical medium: copper lines, optical fibers, radio channels, for example.

The application and transport layers function as end-to-end protocols and the protocols are concerned with communications between the end systems. In contrast, at the data link and network layers, the protocols are concerned with the actual delivery routes that traffic takes. At the network layer, datagrams are addressed to the ultimate source host, but intermediate routers examine the destination address and route the traffic locally in whatever way is necessary.

Local network addressing becomes important at the data link layer, inasmuch as it can be aware of the hardware addresses of hosts only on the same physical wire. Hence, the data link layer shows source and destination addresses of one or more routers.

By assigning different functions to different network layers, it is possible to route traffic across a network (the Internet) that spans the globe. Only the intervening routers need any significant amount of information about the inter-network structure, the hosts need to know only which traffic is local and which is not.

Reliability of TCP transmission is based on use of acknowledgments of receipt, requests of retransmission and use of timeouts. IP transmission does not offer any guarantee for transmission rate, bandwidth, delay, and throughput. In other words, IP protocol does not provide any quality-of-service guarantees unlike another widely used protocol, the asynchronous transfer mode (ATM).

As stated previously, internet protocol (IP) operates at the network layer to route packets across networks independent of the network medium and the data link layer serves for transmitting data across a single network that can consist of several kinds of physical medium.

High speed networks, such as SONET (Synchronous Optical Network) and SDH (Synchronous Digital Hierarchy) use fiber as the physical transmission medium. Today optical networks, being a part of public telecommunication infrastructure, convey a remarkable part of Internet traffic.

Next, protection of an optical network against fiber cuts is shortly explained. The basic principle in optical protection is to arrange a reserve path for traffic. The reserve path means another fiber and another route. Two fundamental protection concepts are used for simple point-to-point links: 1+1 protection and 1:1 protection.

FIG. 2A depicts 1+1 protection, where traffic is transmitted simultaneously on two separate fibers from the source to the destination. One fiber is the working fiber and the other is the protection fiber, wherein the splitter transmits the same data to both of the fibers. Thus, in 1+1 protection, there are two fibers from the source to the destination and traffic is transmitted simultaneously on two separate fibers. The switch selects one of the two fibers for reception. If the working fiber is cut, the destination switches over to the protection fiber and continues to receive data. The switching time is very fast, around 2 ms.

FIG. 2B depicts 1:1 protection. Traffic form the source is transmitted over only one fiber at a time, i.e. over the working fiber. In normal operation another fiber, i.e. the protection fiber, is “cold”; no data is transferred. In an unidirectional communication system a fiber cut is detected by the destination and not the source. Thus, if working fiber fails, the destination detects it, whereupon an optical switch switches over to the protection fiber. Then the destination must tell the source, using a signaling protocol, to switch over to the protection fiber. In bi-directional communication, a fiber cut will be detected by both the source and the destination. In the 1:1 protection optical switches at both ends of the link are required. Switching time is clearly larger than in 1+1 protection.

IP-routers take care of routing IP-packets in the Internet. Routers forward network traffic from one connected network to another. Further, the networks can be optical networks and, in addition, there might be several intermittent optical networks there between. What complicates matters in using IP-routers to route IP-packets through an optical network is that the IP-network and the optical network consist of many layers. Each layer in both networks has its own protection. Moreover, there is no interworking between the protection mechanism of the optical network and the network layer of the Internet. Thus, the network layer, at which the Internet Protocol (IP) operates, is fully independent of the optical layer of the optical network and, correspondingly, of protection of a fiber.

A drawback of the above-described features is that IP-routers have no way of knowing how the optical transport layer is set up, i.e. the IP layer is quite unaware of the optical routes between nodes. Accordingly, when arranging optical protection against fiber cuts no attention is paid to the nature of traffic being transmitted over the optical network. The drawback will be more apparent in connection with the quality of service (QoS) that is being specified for Internet transmission. In prior art, the Internet protocol (IP) sees the optical layer as a simple point-to-point connection without capacity usage optimized to match QoS levels of the Internet protocol (IP). On the other hand, the optical layer does not support the QoS of the Internet Protocol.

### SUMMARY OF THE INVENTION

An objective of the present invention is to devise a method that makes possible the interworking of optical protection and IP-layer protection in order to support QoS routing and IP-packet forwarding.

The objective is achieved by configuring optical point-to-point links to form a part of a ring network and by arranging different protection types for different links. By using 1+1 protection or 1:1 protection for each of the optical links in a ring network, each optical link can be provided with an appropriate protection level corresponding to the nature of the Internet traffic being transmitted over the link.

The high protection level of a link guarantees almost uninterrupted transmission of the Internet traffic, despite a link failure caused by a fiber cut, at the same bit rate as prior to the failure. This protection level is achieved with 1+1 protection. The optical layer can offer this protection for high priority Internet traffic that does not tolerate delay.

The middle protection level of a link guarantees transmission of the Internet traffic at the same bit rate as prior to the failure, despite link failure caused by fiber cut, but after a short interruption period. Optical layer can offer this protection for high priority Internet traffic tolerating some delay. This protection level is achieved with 1:1 protection.

The main difference between the high and middle protection levels is in their response times to failures.

The low protection level of a link does not guarantee uninterrupted transmission of the Internet traffic in case of a link failure caused by a fiber cut. Hence, no protection is offered in the optical layer. When the Internet traffic is dropped, the IP-layer will soon detect the missing link and, in consequence of this, will change routing tables to accommodate to the new situation. The Internet traffic that used the missing link will be restored if the rest of the network is not congested.

In the middle protection level optical signaling at the optical layer takes care of protection wherein the IP-layer does not know when protection actions are carried out.

The protection levels at the optical layer may have corresponding priority levels in the IP-layer.

### BRIEF DESCRIPTION OF THE DRAWINGS

The invention will now be described in more detail with reference to the accompanying drawings, in which

FIG. 1 depicts the layer model of TCP/IP protocol;

FIG. 2A shows 1+1 protection of an optical link;

FIG. 2B shows 1:1 protection of an optical link;

FIG. 3 illustrates an optical ring network;

FIG. 4 depicts arrangement as seen from the IP-layer's point of view, and

FIG. 5 shows 1:N protection of an optical link.

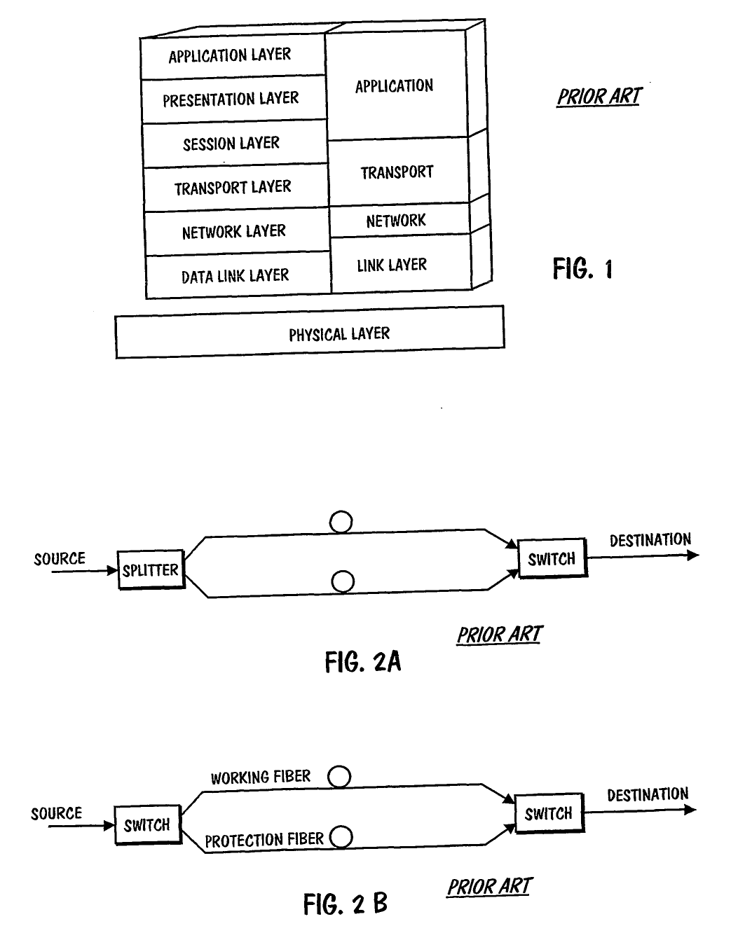

### DETAILED DESCRIPTION OF THE PREFERRED EMBODIMENT

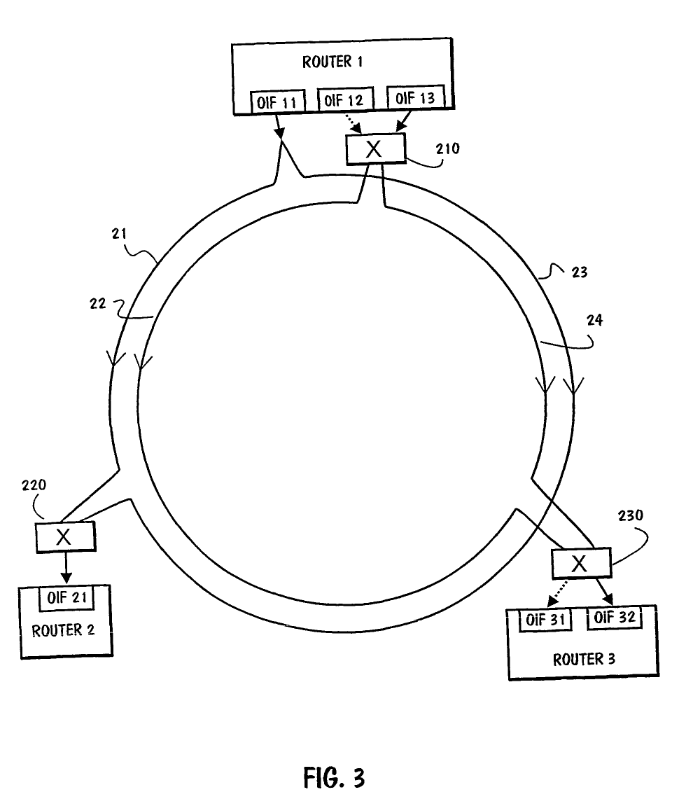

FIG. 3 illustrates a ring network comprising optical fibers as the physical medium. The network is comprised of two optical rings and three routers connected to the rings via optical interfaces (OIF). Rings offer a high degree of availability in the presence of failures while being topologically simple. Although links can fail because of fiber cut and nodes may fail because of power outages or equipment failures, the ring network is resilient to failures because it provides at least two separate paths between any pair of nodes. The paths do not have any nodes or links in common, expect the source and destination nodes.

Referring to FIG. 3, traffic between routers 1 and 2 is 1+1 protected: fiber 21 is the working fiber and fiber 23 is the protection fiber. Parallel fibers having traffic to same direction can be replaced by a single fiber that can carry multiple optical channels. Wavelength division multiplex (WDM) technology, for example, can be used for this purpose, wherein wavelengths are added into and removed from the fibers by using WDM multiplexers and demultiplexers, respectively. Traffic between routers 1 and 2 as well as traffic between routers 1 and 3 are bi-directional. For simplicity, only the directions of traffic from router 1 to routers 2 and 3 are considered hereafter.

Router 1 has interface OIF11 for transmitting data to router 2, and, accordingly, router 2 has interface OIF21 for receiving data from router 1. Switch 220 monitors optical power from fiber 21 and if the optical power disappears due to a fiber cut, optical switch 220 simply switches over to fiber 23 and continues to receive data. The switching time is very short; around 2 ms.

Only one optical interface is required at both ends. For example, if total capacity of the fibers between router 1 and router 2 is 2,5 Gbit/s, then instead of offering a maximum capacity of 5 Mbit/s for traffic between routers 1 and 2, only 2,5 Gbit/s can be offered. On the other hand, due to 1+1 protection this capacity is available not only in normal operating conditions, but also during a fiber failure when active protection takes place.

This protection offers high protection level for Internet traffic. In most cases switching over to the reserve fiber is so fast that the IP layer is not at all aware that a failure has occurred in the optical layer. Hence, a point-to-point connection that is 1+1 protected can be offered for clients whose Internet traffic requires extremely reliable connections.

Middle and low protection levels can be offered to traffic between routers 1 and 3. There are two optical interfaces in routers 1 and 3: router 1 has interfaces OIF12 and OIF 13 for transmitting data, and, accordingly, router 3 has interfaces OIF31 and OIF 32 receiving data from router 1. As in the previous example, there is also traffic form router 3 to router 1, but traffic is not shown in the figure. Hence, there are two optical links between routers 1 and 3. If capacity of each of the links between router 1 and router 3 is 2,5 Gbit/s, then the maximum capacity available between the routers is 5 Gbit/s, wherein both fibers are used for the traffic. In that case, a load sharing principle is used in the transmitting router for sharing traffic between optical interfaces OIF 12 and OIF 13.

According to the invention, traffic between router 1 and router 3 is 1:1 protected. According to 1:1 protection scheme, fiber 24 of this link is chosen as the “working fiber” whereas fiber 22 is the “protection fiber”. It should be noted that either of the fibers could be chosen as working fiber. For example, traffic that router 1 transmits via optical interface 12 and optical switch 210 to fiber 24 is protected, whereupon router 3 is always capable to receive that traffic either from fiber 24 via optical switch 230 and optical interface 32 or fiber 22 via optical switch 230 and optical interface 31.

However, in contrast to the basic principle of 1+1 protection where the protection fiber is “cold”, in normal operation traffic is also conveyed via protection fiber 22. Thus, IP-router 1 sends packets through optical interface OIF 13 and optical switch 210 to fiber 24. Packets having low priority are routed through optical interface OIF 12 and optical switch 210 to fiber 22. The same bit rate is offered to all packets being transferred between router 1 and router 3 despite the priority class of the packets.

If a fiber cut takes place in fiber 24, the protection operation according to a 1:1 scheme will be performed. Optical switch 230 detects that no packets, i.e. no light is arriving from fiber 24, whereupon switch 230 switches so that it routes packets from fiber 22 to optical interface 32 and from fiber 24 to optical interface 31. Simultaneously switch 230 informs switch 210 about the switch change, using a signaling protocol, whereupon switch 210 turns to guide packets from optical interface 13 to fiber 22 and from optical interface 12 to fiber 24.

As a result, packets of middle priority are still delivered from router 1 to router 3 but after a short interruption and via another fiber as prior to the fault. Packets having low priority are directed to the broken fiber 24 and therefore these packets are lost.

In the protection scheme described above, packets having low priority are transmitted at the same bit rate as packets having middle priority, but in a fault situation middle-priority traffic survives and low-priority traffic is interrupted. Hence, low-priority traffic always suffers the risk of being dropped.

If a fiber cut takes place in fiber 22, then optical switches 210 and 230 do not change their positions. As a result, middle-priority traffic via fiber 24 survives but low-priority traffic via fiber 22 is interrupted.

In summary, middle priority packets can always be transmitted between router 1 and router 2, despite a fiber cut occurring in whichever of the links.

The router makes decisions on which packets are routed to which optical interface. The decisions are made without knowledge of the underlying optical network. In any case, the operator of the optical network arranges the optical network and protection of the fibers beforehand and configures the routers in an appropriate way so that routers route certain traffic to a certain fiber offering a certain priority level taking into account the requirements of the traffic considered.

Classification of traffic into priority classes can be performed by destinations and/or origins of IP-packets, for example. After classification has been done, protection types between appropriate nodes will be chosen and the links will be configured accordingly. Then routers direct packets into the proper optical interfaces and further to proper optical fibers. However, configuration of the optical links in a ring network is rather static and configuration that has been set is changed seldom. In any case, the router decides how traffic is directed to the fibers.

It is worth noting that the invention combines protection in the IP-layer and protection in the optical layer, although those layers are fully independent of each other. Despite the fact that there is not any control signal flow between the optical layer and the IP-layer, the quality of Internet traffic between nodes is maintained. The current Internet protocol supports both 1+1 and 1:1 protection schemes.

The optical protection switching according to the present invention is particularly suitable for the Internet with emerging Quality of Service (QoS) Routing that is being developed. In QoS routing links between routers are associated with QoS parameters. Routing tables are created separately for different transport classes.

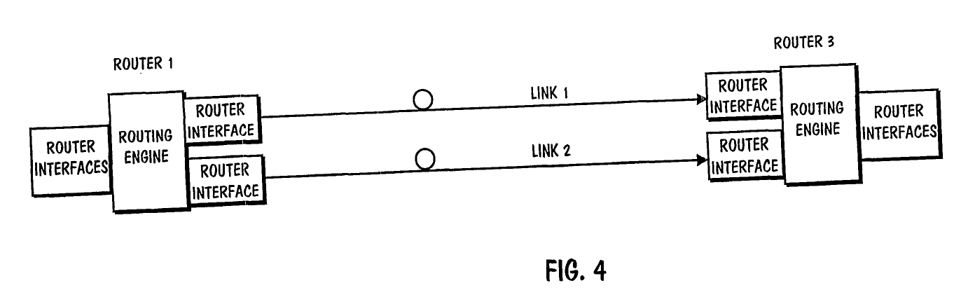

This will be explained in more detail with reference to FIG. 4 and FIG. 3.

FIG. 4 shows routers 1 and 3 of FIG. 3 and the links there between. Moreover, the figure shows arrangement as seen from the IP-layer's point of view. Link 1 corresponds to fiber 24 and link 2 corresponds to fiber 22. Traffic from router 1 to router 3 is considered. Router 1 checks the QoS parameters of the incoming IP-packets. If the parameters indicate that the packets require high reliability and low delay, then the packets are routed via link 1. This route is depicted as solid line arrows in FIG. 3. Other packets, i.e. the packets whose QoS parameters indicate that the packets tolerate more delay and have low reliability requirements, are routed via link 2. This route is indicated with dashed line arrows in FIG. 3. A higher price might be charged for packets traversing link 1 than packets traversing link 2 because of the higher QoS of link 1.

If a fiber brake occurs in link 2, the link is removed for the duration of the repair time. Protection at the IP layer will happen and IP connections are restored in a few seconds, if the IP network is not overloaded. Link 1 suffers only a very short break, if any, and the fault triggers no protection at the IP layer.

At the IP layer three different approaches may be used; a load sharing scheme, a modified QoS packet forwarding scheme, and a QoS routing scheme.

A load sharing scheme is used in present routers but this scheme does not take advantage of the knowledge that link 1 survives and link 2 does not survive after a fiber cut.

In the modified QoS packet forwarding scheme, instead of dropping lower priority packets conveyed via link 1, the packets are directed into link 2, if link 1 threatens to become congested.

In the QoS routing scheme the links have different routing parameters as already described earlier.

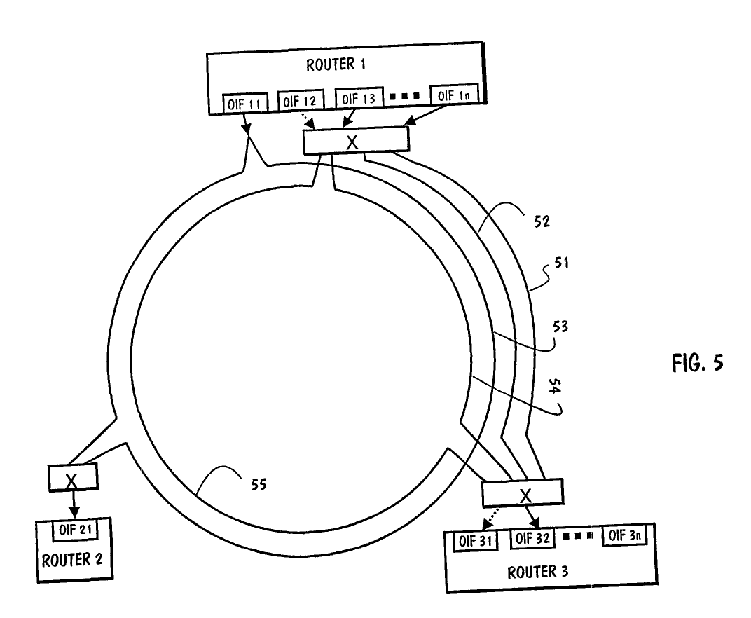

FIG. 5 depicts an optical network allowing five priority levels. The figure differs from FIG. 3 in that in the ring there are four optical fibers between router 1 and router 3. Of course, the number of additional links between routers is not limited to five but any number N of fibers can be used. Then, the protection scheme is known as 1:N. In 1:N protection schemes, N working fibers share a single protection fiber, wherein protection can handle the failure in any of the single working fibers. Therefore, fibers 51, 52,and 54 can each transmit high priority traffic between routers 1 and 3, and fiber 56 carries low-priority traffic. If a fiber cut occurs in any of fibers 51-54, its traffic is routed to fiber 55 and the low-priority traffic of that fiber 55 is dropped.

Accordingly, a different priority level can be specified for each of the fibers 51-54. If a fiber cut occurs, let's say in fiber 52 carrying traffic of highest priority, the traffic will be routed to fiber 55 whose traffic will be dropped. If thereafter a failure occurs in fiber 51, its traffic will be routed to fiber 53 having lower priority and not to fiber 55 because it is conveying traffic having higher priority than that of fiber 51. In addition, total capacity of the router output can be divided between each of the optical interfaces OIF12 . . . OIFN and OIF32 . . . OIFN. Typical capacity of an optical interface today is 2,5 Gbit/s. Then traffic with the rate of 10 Gbit/s can be shared between five links 51-55.

If a 1:N protection scheme is used, then same number of priority levels may be required in the IP-world.

The invention is applicable in a ring network, especially in Metropolitan-Area Networks (MAN) and SONET/SDH networks.

The proposed method is suitable in billing a client, for example. Then charging can be based on the QoS required by the client, not on the amount of traffic, as in prior art.

What is claimed is:

1. A method of protecting packet traffic against failures in an optical network comprising routers, optical fibers, and optical switches interconnecting routers and optical fibers, comprising the steps of:
arranging 1+1 protection comprising two optical links in separate optical fibers for traffic of high priority packets between a transmitting router and the corresponding receiving router;
routing at the transmitting router packets of high priority to both of the optical links, wherein after a fiber cut in either of the optical links occurs the corresponding receiving router continues reception of the packets form the remaining optical link without noticeable delay; and
arranging 1:1 protection comprising at least the first and the second optical link in separate optical fibers for traffic of middle and low priority packets between a transmitting router and the corresponding receiving router;
routing at the transmitting router packets of middle priority to the first optical link,
routing at the transmitting router packets of low priority to the second optical link, and
in response to a fiber cut in the first optical link, rerouting at the transmitting router the packets of middle priority to the second optical link and rerouting the packets of low priority to the first optical link, whereupon at the corresponding receiving router reception of the middle priority packets continues after a short switching delay but the low priority packets are lost;
in response to a fiber cut in the second optical link, retaining routing at the transmitting router, whereupon at the corresponding receiving router reception of the middle priority packets continues without delay but the low priority packets are lost.

2. A method as in claim 1, wherein the optical fibers and the routers are coupled to form a bi-directional ring having at least two optical links between transmitting routers and corresponding receiving routers.

3. A method as in claim 1 or 2, comprising the further steps of:
assigning, at the IP layer of the Internet protocol, different quality-of-service parameters to the optical links of high, middle, and low priority, and
enabling the routers to create different routing tables for different quality-of-service classes.

4. A method as in claim 1, comprising the further step of:
performing rerouting by changing the state of the optical switches both at the transmitting router and at the corresponding receiving router, wherein protection at the optical layer is fully independent of protection at the IP layer.

5. A method as in claim 4, wherein the transmitting router routes packets to appropriate optical interfaces according the priorities of the packets and continues the same routing during the failure period in any of the optical links.

6. A method as in claim 1 or 4, wherein parameters defining quality of service are attached to each of the packets and the transmitting router routes packets to the appropriate optical interfaces according to said parameters.

7. A method as in claim 1, comprising the further steps of:
routing packets of low priority also to the first optical link, wherein packets of low priority are conveyed among packets of middle priority;
directing, in response to congestion of the packets in the first optical link, the packets of low priority to the second optical links.

8. A method as in claim 1, comprising the further steps of:
arranging 1:N protection comprising 1+N links of optical fibers for traffic of N+1 priority classes between a transmitting router and the corresponding receiving router, wherein each optical link conveys packets of different priority classes;
rerouting, in response to a fiber cut in any of the optical links, packets of that link to the link conveying packets of the lowest priority, and
dropping the packets of the lowest priority.

9. A method as in claim 1, comprising the further steps of:
arranging only one optical link to a single optical fiber, wherein the number of links is equal to the number of the optical fibers.

10. A method as in claim 1, comprising the further steps of:
arranging, by using wavelength division multiplexing techniques, a plurality of optical links to a single optical fiber, the number of links is greater than the number of the optical fibers.
